(19) United States
(12) Patent Application Publication
(10) Pub. No.: US 2008/0250681 A1
(43) Pub. Date: Oct. 16, 2008

(54) Indicia usable with consumer products and the use thereof

(75) Inventor: Albert Daniel Jackson, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company

(21) Appl. No.: 11/784,900

(22) Filed: Apr. 10, 2007

(51) Int. Cl. G09F 3/00

(52) U.S. Cl. 40/299.01

(57) ABSTRACT

A message relating to a consumer product. The message comprises a first group of indicia are relating to one of the five senses, followed by a second group of indicia relating to usage of that product. By first providing indicia relating to the senses, the user will better understand the desired outcome possible with proper use of the consumer product and a potential purchaser will better understand the purchase decision.

### FIELD OF THE INVENTION

The invention relates to indicia helpful to a user of a consumer product, and more particularly to indicia which may be presented with that product at the point of sale.

### BACKGROUND OF THE INVENTION

Consumer products surround us in everyday life. Such products range from the mundane and disposable to the expensive and long term. For example, consumer products may range from single use items such as food and diapers to complex items such as printers and kitchen appliances. Consumer products may also include cleaning products such as floor wipes, dusters, diapers, shampoo, detergent, air fresheners, and the like.

It is often necessary to provide indicia for the purchaser and/or user of a consumer product. The indicia may help the purchaser/user select the most appropriate product for a particular task. The indicia to may help the purchaser/user deploy the product in the intended, proper, and most efficacious manner.

For example, if the purchaser/user is attempting to select a cleaning product, it may be helpful for the purchaser, and ultimate user, to know which cleaning product is best suited for a particular surface to be cleaned, which cleaning product will or will not leave behind a scent, have a scent be apparent during the cleaning task, etc.

While instructions for use of the product may provide some help in this regard, such instructions may fall short. For example, if the instructions are thought to be too detailed, they may not be read at the point of purchase. This may prevent the instructions from being helpful when trying to select the most appropriate product for a particular task.

Sometimes packaging for a consumer product contains a listing of the benefits of that product. Such benefits may be intended to entice a prospective purchaser to select that product. However, a simple listing may not tie the benefits to a particular or proper usage of that product. And again, a detailed listing may not even be read at the point of purchase. Even if the instructions for use or listing of the benefits is apparent at the point of use, the purchaser/user may not properly understand the intended message.

To alleviate this situation, the consumer product may have one or more first indicia associated therewith, which first relate the consumer product, or use thereof, to one of the five senses. This provides a universal grounding for what that product may be intended to accomplish. The consumer product may also be provided with one or more second indicia. The second indicia may be directed to the usage of that product. By providing the indicia in this order, a first plurality of indicia to relating to one of the five senses, and a second plurality of indicia relating to the usage of that product, the purchaser/user is more likely to appropriately select and use a product.

### SUMMARY OF THE INVENTION

In one embodiment the invention may comprise a message for a user of a product. The message may comprise indicia disposed in a particular sequence and relating to a product. Such message may comprise a first plurality of indicia. Each indicium of the first plurality may relate to one of the five senses. The message may also comprise a second plurality of indicia. Each indicium of the second plurality may relate to one or more desired actions related to using that same product. The indicia may be provided in the sequence of having the first plurality of indicia being disposed before, and being discerned prior to, the second plurality of indicia. If desired, one or more additional indicia to may be interspersed among the first and/or second plurality of indicia.

### BRIEF DESCRIPTION OF THE DRAWINGS

FIG. 1 is a message for the user of a consumer product having two parallel streams of indicia, wherein the consumer product is a scented floor cleaning wipe.

FIG. 2 is a message for the user of a consumer product having two parallel streams of indicia, wherein the consumer product is an unscented floor cleaning wipe.

### DETAILED DESCRIPTION OF THE INVENTION

Indicia may come in several forms and formats. For example, the indicia may be in the form of written or audible words. Each indicium may be a single word, a cluster of two words, a cluster of three words, or more. The words may be provided in a single language or may be provided in bilingual or trilingual form, etc.

Additionally, indicia provided in the form of words may be provided in plural formats. For example, written words may be provided with an audio track. This allows the person to whom the indicia are directed to simultaneously both read and hear the message. If plural formats are used, the indicia may be identical or, one format may be more lengthy and/or more detailed than the other. For example, if both written and audible words are provided, the audible words may elaborate upon the message provided by the written words.

Indicia may also be provided in the form of graphics. Graphical indicia include realistic indicia such as photographs and detailed drawings. Graphical indicia also includes representative indicium such as cartoons and line drawings. More realistic indicia may be desired when the message is complex or subject to misinterpretation. More representative indicia may be desired, where the message is to be quickly comprehended or the indicia may be lost among advertising, etc.

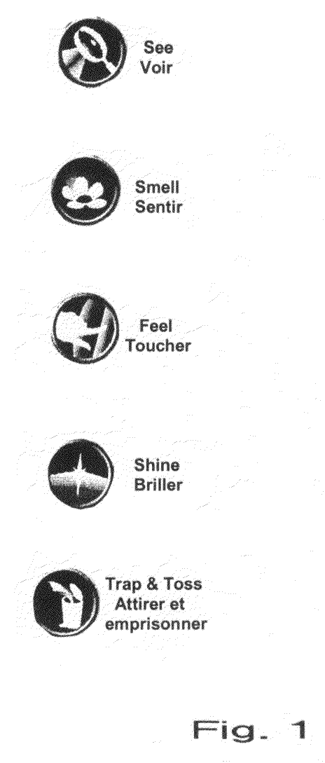

Referring to FIG. 1, the indicia may be related to one or more of the five senses. The five senses are universally recognized to be the senses of sight, sound, smell, touch, and taste. The sense of sight is realized through what one can visually observe. The sense of sound is realized through what one can hear. The sense of smell is realized through olfactory determination. The sense of touch is realized through tactile sensations against the skin. The sense of taste is realized through items placed on receptors in the oral cavity and on the tongue.

The indicia relating to one or more of the senses may be directed to a desired outcome, which is possible when using the consumer product. For example, an indicium may relate to how the user's body would look from using an exercise product (weight loss, etc.), how a food would taste upon cooking, how a surface would appear when cleaned, etc. A particular indicium relating to one of the five senses may also relate to how the consumer product is to be used.

One or more indicia may relate to how a consumer product is to be used, or to other desired actions involving the consumer product. For example, an indicium may direct a user to hold the consumer product in a particular manner, to use the consumer product with a particular motion, or to use a consumer product for a minimum or maximum period of time. A collection of indicia may provide the message that the consumer product is to be used with a particular sequence of actions or, in combination with or not in combination with, other consumer products.

The indicia may be disposed in groups. The groups may be arranged sequentially and have substantially similar, or even substantially identical, forma and formats of the indicia in each group. Alternatively, the groups may be defined so that it is apparent which indicium longs to a particular group. For example, indicia may be understood to be in a first group, second group, third group etc., through the use of different graphics, type fonts (style, size, etc.), formats (written graphical, etc.) and combinations thereof.

Groupings of indicia found in the prior art often use a first group of indicia to provide instructions for using the consumer product, and then a second group of indicia to relate to one of the five senses. For example, a food product may instruct the user to “Just Heat & Eat!” A cleaning product may instruct the user to “Clean Easy, Breathe Easy!” Each of these products first provides instructions for using the consumer product (e.g. heat it, clean with it). Following the instructions for using the consumer product is an indicium relating to one of the five senses (e.g. taste, smell).

However, it has been found that it is beneficial to present one or more indicia relating to the five senses before presenting one or more indicia relating to the use of that product. By providing a first group of one or more indicia relating to at least one of the five senses, then providing a second group of one or more indicia relating to at least one instruction for use of or relating to a desired use of the consumer product, the benefits of a simple message and a message which directs the user towards the desired result can be obtained

For example, in FIG. 1, the first group of indicia comprises, in order, the senses of see, smell, and feel. It is believed this arrangement corresponds to what the user of a cleaning product might experience when entering a room.

For example, if the cleaning product were a dry cloth for use on a floor, such a product would likely be used in the kitchen. When the user enters the kitchen the first sense/sensation the user might experience is to see that the kitchen is clean or dirty. The second sense/sensation, the user might experience is to smell scent or perfume left behind by the product when the kitchen is clean or smell the odor of trash or debris when the kitchen is dirty. The next sense/sensation the user might experience is to feel a clean surface, such as the floor, or to feel crumbs and trash to be cleaned from the floor.

In FIG. 1, the second group of indicia comprises the instructions to trap and toss. By this it is meant that the user can trap dirt cleaned by the cloth, and toss the dirt and soiled cloth away so that both are discarded. This message minimizes the opportunity for the user to misunderstand the proper use and disposal of the consumer product. The second group of indicia, may end with directions to discard or dispose of the product so that it is not used beyond its useful life.

However, the second group of indicia is not so limited. The second group of indicia may include a message relating to how the consumer product is to be deployed. For example, the second group of indicia may include assembly instructions, instructions for preparation of that consumer product or, other elements to be used in conjunction with that consumer product. By way of further nonlimiting example, the second group of indicia may include a directive to prepare a surface for cleaning or applying a protective coating thereto. Alternatively or additionally, the second group of indicia may nonlimitingly include a directive to prepare other food or properly use cooking utensils, therefor.

The first group and second group of indicia may be presented in series, i.e. all indicia of the first group occur before and are presented before each indicium of the second group. This arrangement provides the benefit that there is less opportunity for confusion of the message intended by the two or more groups of indicia.

Alternatively, one or more indicia may be interposed within each group or are between sequential groups. This arrangement provides the benefits that additional or mixed messages may occur, providing that the combined message does not become unduly complex.

Of course the first group of indicia may comprise a single indicium or plural indicia relating to a particular, or one or more, of the senses. Likewise the second group of indicia may comprise a single indicium or plural indicia relating to the desired or suggested usage of that product.

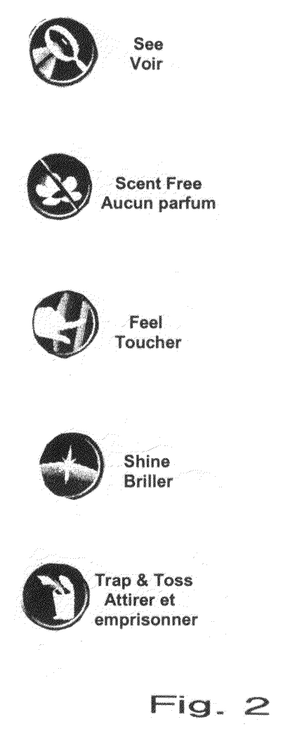

If desired, one or more indicia may relate to the absence of a feature or step. For example, referring to FIG. 2 one or more indicia in the first group to may relate to the absence of one or more of the five senses. In FIG. 2, the third indicium specifically notes the absence of scent. This may be important to a purchaser/user, who is particularly sensitive to perfumes, may desire to use other perfumes, etc.

Additionally or alternatively, one or more indicia in the second group may suggest the user refrain from a particular action. For example, one or more indicia in the first group may apprise the purchaser/user that the consumer product is unscented or would be tasteless if ingested. One or more indicia in the second group, may apprise the user that the consumer product is to be used without first being wetted, may be eaten without first being heated, etc.

Referring to FIGS. 1-2, each group of indicia may comprise a single stream of indicia or plural streams of indicia. In FIGS. 1-2, each group of indicia is presented twice, once in a first stream of words and again in a second stream of graphics. The two streams may be presented in parallel and/or have an equal or unequal number of corresponding indicia. Two or more indicia are said to be corresponding when they present substantially the same portion of the message to the purchaser/user.

FIGS. 1-2 illustrate more written indicia than graphic indicia, because the two written words directing the user to “trap and toss” the cleaning cloth are also represented by a single corresponding graphic indicium. Presenting this message with corresponding parallel indicia reduces the likelihood either such indicium would be overlooked.

Presenting each group of indicia in two, three, or more parallel streams also provides the benefit that the repeated message is more likely to be understood.

The first and second group of indicia may comprise equal or unequal numbers of individual indicia. For example, and with continuing reference to FIGS. 1-2, the first group may contain a greater number of indicia than the second group. This arrangement may provide the benefit that relatively more senses may be appealed to without unduly increasing the length or complexity of the message. Alternatively, the second group may contain a greater number of indicia. This arrangement may provide the benefit that relatively more detailed instructions may be included without unduly increasing the length or complexity of the message. In a degenerate case, the number of indicia in the first and second groups may be equal. This arrangement provides the benefit of a message balanced between appealing to the senses and instructing in the use of the consumer product.

The indicia may be presented directly on the product or on packaging therefor. This provides the benefit that the message presented by the indicia will be immediately apparent to the user/purchaser at the point of use and/or the point of purchase. In another embodiment, the indicia may be presented on advertising for the consumer product. Such advertising may be printed media, visually discerned by a potential purchaser/user. Alternatively, the advertising may be radio or audible at the point of purchase. The advertising may also be television, having a combination of visually and audibly discernible messages.

Of course, one will realize the invention is not limited to placing the message in advertising directly on the product/packaging therefor. The message may be placed, in one form on advertising. The same, substantially similar, or complementary message (or a combination thereof) may be presented on the packaging for the consumer product. Yet another message, which is the same, substantially similar, or complementary (or combination thereof) may be presented on the product itself. Repetition and coordination of these messages increases the chances of the message being discerned and understood by the purchaser/user.

One of skill will recognize the invention is not necessarily limited to use with consumer products. The invention may also be used with services. Exemplary, nonlimiting examples of such services may include health programs, financial services and product warranties.

While the Specification concludes with claims particularly pointing out and distinctly claiming the present invention, one of skill will understand the claims are not limited to those specific embodiments, but instead include all variations thereof.

1. A message for a user of a product comprising indicia disposed in a particular sequence and relating to a product, said message comprising:
a first plurality of indicia, each indicium of said first plurality relating to one of the five senses;
a second plurality of indicia following said first plurality, each indicium of said second plurality relating to one or more desired actions using said product.

2. A message according to claim 1 wherein said first indicium of said first plurality comprises the sense of sight.

3. A message according to claim 1 wherein said last indicium of said second plurality comprises the action of discarding said product from further use.

4. (canceled)

5. A message according to claim 1 wherein said number of indicia in said first plurality is greater than the number of indicia in said second plurality.

6. A message according to claim 1 wherein said message is disposed on said product or packaging therefor.

7. A message according to claim 6 wherein each said plurality is presented in order without any intervening indicia from said other plurality interposed in that plurality.

8. A message according to claim 7 wherein each said plurality of indicia is presented without any intervening indicia not in that plurality disposed therein.

9. A method of conveying information to a user of a product, said method comprising the steps of:
providing indicia in a sequence, where said indicia are related to the desired end use of that product and wherein said step of providing said indicia comprises;
providing a first plurality of indicia, each indicium of said first plurality relating to one of the five senses;
providing a second plurality of indicia following said first plurality, each indicium of said second plurality relating to one or more desired actions using said product, whereby both said pluralities of indicia can be perceived by a user.

10. method according to claim 9 wherein said steps of providing first and second pluralities of indicia comprises the steps of providing parallel streams of corresponding indicia in each said plurality.

11. A method according to claim 9 wherein said steps of providing first and second pluralities of indicia comprise the steps of providing an unequal number of indicia in each plurality.

12. A message according to claim 1 comprising plural streams of indicia presented in parallel wherein a first stream comprises a two pluralities of indicia comprising written words and a second stream comprises two pluralities of indicia comprising symbols, wherein said words and said symbols are correspondingly presented in parallel.
